(19) United States
(12) Patent Application Publication
(10) Pub. No.: US 2026/0264603 A1
(43) Pub. Date: Sep. 10, 2026

(54) LAMP CONTROL SYSTEM FOR VEHICLE AND METHOD OF CONTROLLING THE SAME

(71) Applicant: Hyundai Mobis Co., Ltd., Seoul (KR)

(72) Inventors: JungSub LIM, Yongin-si (KR); Ki Dong LEE, Yongin-si (KR)

(73) Assignee: Hyundai Mobis Co., Ltd., Seoul (KR)

(21) Appl. No.: 19/455,997

(22) Filed: Jan. 22, 2026

(30) Foreign Application Priority Data
Mar. 7, 2025 (KR) 10-2025-0030017
Apr. 14, 2025 (KR) 10-2025-0047801

(51) Int. Cl. B60Q 1/14; G06V 10/26; G06V 20/56; H05B 47/125

(52) U.S. Cl. CPC B60Q 1/143; G06V 10/26; G06V 20/588; H05B 47/125; B60Q 2300/054

(57) ABSTRACT

A lamp control system for a vehicle and a method of controlling the same are provided. The lamp control system includes an image input unit configured to receive forward image data of the vehicle from a camera sensor; and an image analysis unit configured to analyze the forward image data of the vehicle using an image processing algorithm to determine boundary line information of a travelable road and to generate lighting pattern information to control a vehicle lamp based on the boundary line information. The vehicle lamp includes a plurality of light sources, each of which has at least one of a light-emitting position and a light intensity controlled according to the lighting pattern information.

### CROSS REFERENCE TO RELATED APPLICATION

The present application claims priority to Korean Patent Application No. 10- 2025-0030017, filed Mar. 07, 2025, and Korean Patent Application No. 10-2025- 0047801, filed Apr. 14, 2025, the entire contents of which is incorporated herein for all purposes by this reference.

### BACKGROUND

### Field

The present invention relates to a lamp control system for a vehicle and a method of controlling the same, and more specifically, to a lamp control system for a vehicle and a method of controlling the same, which may distinguish boundary lines of a travelable road of a vehicle and controlling the intensity and height of light in areas outside the boundary lines in which the vehicle cannot travel, thereby providing maximum visibility to a driver of a host vehicle and minimizing glare to users (e.g., pedestrians) present in the outer areas.

### Description of the Related Art

Vehicle headlights are essential components for nighttime driving. Conventional headlights have only a simple on/off function, but headlights are gradually evolving to provide drivers with maximum nighttime visibility. Representative functions of such headlight include high beams and low beams. The high beams project strong beams at a relatively high angle to provide long-range illumination to the driver, providing convenience to the driver of the host driver, but have a disadvantage of causing glare to drivers of preceding or oncoming vehicles or roadside users (e.g., pedestrians).

Accordingly, the operation of controlling the on/off of high beams based on driving conditions is required, and such an operation can reduce driver concentration, and thus high beam assistance (HBA), which is a technology for automatically turning on and off high beams, has been developed.

The HBA is a technology of analyzing image data from a forward camera mounted on a vehicle and automatically turning off high beams when other road users (preceding or oncoming vehicles, pedestrians, and the like) are recognized. The HBA is effective technology but has a disadvantage in which the high beams are turned off when there is even a single vehicle on the road and in environments in which vehicles appear sporadically, the high beams are turned on and off repeatedly, or theirfunctions are limited.

To address such a disadvantage, an adaptive driving beam (ADB) has been developed. The ADB divides an emitting range of the high beams into multiple segments and controls the segments individually. That is, by partially turning off the high beams only in the area of other vehicles recognized, the ADB provides the driver of the host vehicle with maximum nighttime illumination. In this way, it is apparent that the ADB provides a better lighting environment than the HBA. However, the ADB typically has 10 to 100 segments, each of which has a relatively large beam area, and thus has an increased lighting time compared to the HBA, but the relatively large beam area makes precise beam control difficult for various driving environments.

Accordingly, a high-definition adaptive driving beam (HD-ADB) technology has recently been developed.

The HD-ADB is based on a system with a beam control resolution 10 times or more that of the conventional ADB. Typically, the HD-ADB has segments with 10K pixels or more, and an HD-ADB system is rapidly being installed, particularly in the European automotive industry.

Accordingly, based on the HD-ADB, it is necessary to further classify driving environments and apply precise lighting control methods optimized for each situation.

In this regard, Korean Patent Registration No. 10-1325791 ("vehicle headlight control device and control method thereof") discloses a technology for recognizing lanes in a road image and controlling an angle of headlights installed in a vehicle based on a curvature of the recognized lanes.

### SUMMARY

The present invention relates to a lamp control system for a vehicle and a method of controlling the same, and more specifically, to a lamp control system for a vehicle and a method of controlling the same, which may distinguish boundary lines of a travelable road of a vehicle and controlling the intensity and height of light in an area outside the boundary lines in which the vehicle cannot travel, thereby providing maximum visibility to a driver of a host vehicle and minimizing glare to users (e.g., pedestrians) present in the outer area.

According to one general aspect, a lamp control system for a vehicle includes an image input unit configured to receive forward image data of the vehicle from a camera sensor; and an image analysis unit configured to analyze the forward image data of the vehicle using an image processing algorithm to determine boundary line information of a travelable road and to generate lighting pattern information to control a vehicle lamp based on the boundary line information, wherein the vehicle lamp includes a plurality of light sources, each of which has at least one of a light-emitting position and a light intensity controlled according to the lighting pattern information.

The image analysis unit may include a boundary line determination unit configured to analyze the forward image data of the vehicle to determine the boundary line information of the travelable road of the vehicle; an area segmentation unit configured to segment an outer area outside the determined boundary line information into a plurality of areas based on the vehicle; and a pattern generation unit configured to generate the lighting pattern information based on the segmented areas.

The boundary line determination unit may analyze the forward image data of the vehicle and, when a predetermined object is recognized, determines the boundary line information based on the corresponding predetermined object.

The boundary line determination unit may analyze the forward image data of the vehicle and, when no predetermined object is recognized, determines that an outermost lane line among recognized lane lines is the boundary line information.

When no predetermined object is recognized by analyzing the forward image data of the vehicle, a virtual boundary line is generated outside a recognized lane line, and the generated virtual boundary line is determined to be the boundary line information.

The area segmentation unit may segment the outer area, based on a predetermined height range from a road surface, into a first segmentation area closest to the road surface and a second segmentation area comprising the remaining outer area, and the pattern generation unit may generate the lighting pattern information so that light sources corresponding to the second segmentation area are turned off or dimmed.

The area segmentation unit may segment the outer area, based on a predetermined height range from a road surface, into a first segmentation area closest to the road surface, a second segmentation area closest to the first segmentation area, and a third segmentation area comprising the remaining outer area, and the pattern generation unit may generate the lighting pattern information so that light sources corresponding to the second segmentation area and the third segmentation area are turned off or dimmed in the same manner or so that the light sources corresponding to the second segmentation area and the light sources corresponding to the third segmentation area are turned off or dimmed differently.

The pattern generation unit may generate the lighting pattern information so that a luminous intensity of each light source corresponding to the first segmentation area gradually decreases as a distance from a host vehicle increases.

The pattern generation unit may generate the lighting pattern information so that a luminous intensity of each light source corresponding to the first segmentation area gradually decreases as a distance from a host vehicle increases.

According to a general aspect, a method of controlling a vehicle lamp, in which each operation is performed by a computational processing unit, includes an image input operation of receiving forward image data of a vehicle from a camera sensor; and an image analysis operation of analyzing the forward image data of the vehicle received in the image input operation using an image processing algorithm to determine boundary line information of a travelable road and to generate lighting pattern information to control a vehicle lamp based on the boundary line information.

The image analysis operation may include a boundary line determination operation of analyzing the forward image data of the vehicle to determine the boundary line information of the travelable road of the vehicle; an area segmentation operation of segmenting an outer area outside the determined boundary line information into a plurality of areas based on the vehicle; and a pattern generation operation of generating the lighting pattern information based on the segmented areas.

The boundary line determination operation may include analyzing the forward image data of the vehicle and, when a predetermined object is recognized, determining the boundary line information based on the corresponding predetermined object.

When no predetermined object is recognized by analyzing the forward image data of the vehicle, the boundary line determination operation may include determining that an outermost lane line among recognized lane lines is the boundary line information or generating a virtual boundary line outside the recognized lane line, and determining that the generated virtual boundary line is the boundary line information.

The area segmentation operation may include segmenting the outer area, based on a predetermined height range from a road surface, into a first segmentation area closest to the road surface and a second segmentation area comprising the remaining out area, and the pattern generation operation may include generating the lighting pattern information so that light sources corresponding to the second segmentation area are turned off or dimmed.

The area segmentation operation may include segmenting the outer area, based on a predetermined height range from a road surface, into a first segmentation area closest to the road surface, a second segmentation area closest to the first segmentation area, and a third segmentation area comprising the remaining outer area, and the pattern generation operation may include generating the lighting pattern information so that light sources corresponding to the second segmentation area and the third segmentation area are turned off or dimmed in the same manner or so that the light sources corresponding to the second segmentation area and the light sources corresponding to the third segmentation area are turned off or dimmed differently.

The pattern generation operation may include generating the lighting pattern information so that a luminous intensity of each light source corresponding to the first segmentation area gradually decreases as a distance from a host vehicle increases.

The pattern generation operation may include generating the lighting pattern information so that a luminous intensity of each light source corresponding to the first segmentation area gradually decreases as a distance from a host vehicle increases.

### BRIEF DESCRIPTION OF THE DRAWINGS

FIG. 1 is an exemplary view illustrating a configuration of the lamp control system for a vehicle according to an embodiment of the present invention.

FIG. 2 is an exemplary view illustrating a process of setting a right boundary line of a lane in the lamp control system for a vehicle and a method of controlling the same according to the embodiment of the present invention.

FIGS. 3 and 4 are exemplary views illustrating lighting pattern information segmented into each segmented area according to the lamp control system for a vehicle and a method of controlling the same according to the embodiment of the present invention.

FIG. 5 is an exemplary flowchart illustrating a method of controlling a vehicle lamp according to an embodiment of the present invention.

### DETAILED DESCRIPTION

The above-described purpose, features, and advantages of the present disclosure will become clearer through the following embodiments in conjunction with the attached drawings. The following specific structural and functional descriptions are merely illustrative for the purpose of describing embodiments according to the concept of the present invention, and the embodiments according to the concept of the present invention may be implemented in various forms and should not be construed as limited to embodiments in the specification or the application. Since the embodiments according to the concept of the present disclosure may be variously changed and may have various forms, specific embodiments will be illustrated in the drawings and described in detail in the specification or the application. However, it should be understood that this is not intended to limit the embodiments according to the concept of the present invention to a specific form and includes all changes, equivalents, and substitutions included within the spirit and technical scope of the present invention. The term such as first or second may be used to describe various components, but the components are not limited by the term. The terms are used only for the purpose of distinguishing one component from another, and for example, a first component may be referred to as a second component, and similarly, the second component may also be referred to as the first component without departing from the scope according to the concept of the present disclosure. It should be understood that when a first component is described as being "connected" or "coupled" to a second component, the first component may be directly connected or coupled to the second component, but a third component may also be present therebetween. On the other hand, it should be understood that when a first component is described as being "directly connected" or "directly coupled" to a second component, a third component is not present therebetween. Other expressions for describing the relationship between components, in other words, expressions such as "between" and "directly between" or "adjacent to" and "directly adjacent to" should be construed in the same manner. The terms used in the specification are only used to describe specific embodiments and are not intended to limit the present disclosure. The singular includes the plural unless the context clearly dictates otherwise. In the specification, it should be understood that the term "comprise" or "have" is intended to specify that a stated feature, number, step, operation, component, part, or a combination thereof is present and does not preclude the possibility of the presence or addition of one or more other features, numbers, steps, operations, components, parts, or combinations thereof. Unless defined otherwise, all terms used herein, including technical or scientific terms, have the same meaning as commonly understood by those of ordinary skill in the art to which the present disclosure pertains. The terms defined in a generally used dictionary should be construed as having meanings that coincide with the meanings of the terms from the context of the related technology and are not construed as an ideal or excessively formal meaning unless clearly defined in the specification. Hereinafter, the present disclosure will be described in detail by describing preferred embodiments of the present disclosure with reference to the accompanying drawings. The same reference numerals in each drawing indicate the same member.

In addition, a system refers to a set of components including devices, mechanisms, and units that are organized and interact regularly to perform necessary functions.

Headlights of a vehicle provide drivers with night vision, and their representative functions include high beams (or driving beams) and low beams. A lamp control system for a vehicle and a method of controlling the same relates to a technology for precise control of high beams.

That is, high beams project a strong beam at a relatively high angle to provide long-range illumination to the driver of the host vehicle, but can cause glare to drivers of preceding or oncoming vehicles, or other roadside users (e.g., pedestrians), and when highly reflective structures, such as signs, are present, the reflection of the high beams can make it difficult for the driver to read the signs.

Accordingly, in the present invention, by distinguishing between outer areas of a road, that is, a road area in which vehicles can travel and the outer area in which the vehicles cannot travel and controls the light intensity and height of the high beams in the outer area, it is possible to provide the driver with maximum illumination (sufficient light is provided in the road area in which vehicles can travel), minimize glare to other users (drivers of oncoming vehicles and preceding vehicles, pedestrians, and the like), and also increase the energy efficiency of a light source. In addition, it is possible to provide appropriate light to highly reflective objects, such as traffic signs typically disposed in the outer area, thereby reducing driver glare and improving object visibility.

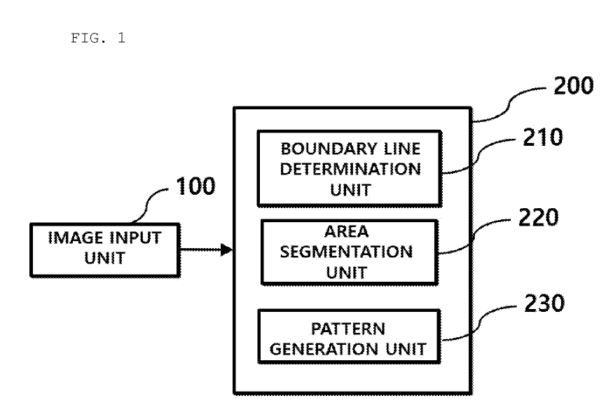

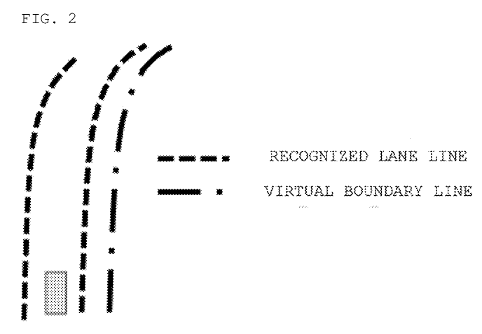

FIG. 1 is an exemplary view illustrating a configuration of a lamp control system for a vehicle according to an embodiment of the present invention, and the lamp control system for a vehicle according to the embodiment of the present invention will be described in detail with reference to FIG. 1.

As illustrated in FIG. 1, the lamp control system for a vehicle according to the embodiment of the present invention includes an image input unit 100 and an image analysis unit 200. Each component is included in a computational processing unit including a CPU to perform operations.

Detailed description of each component will be described below.

The image input unit 100 preferably receives forward image data of the vehicle from a camera sensor and the like mounted on the vehicle. The vehicle forward image data refers to a forward image of the vehicle while traveling and includes various lane line information and roadside structure information. For example, the forward image data of the vehicle includes various lane line information and roadside structure information, such as white lane lines (lane boundary lines for the same direction), yellow lane lines (lane boundary lines for oncoming lanes), blue lane lines (lane boundary lines for bus-only lanes), dotted lines (lane changeable section of a lane available for same-direction travel), solid lines (sections in which lane changes are not possible), double solid lines (sections in which lane changes or parking are not possible), guardrails, medians, streetlights, etc.

The image analysis unit 200 preferably analyzes the forward image data of the vehicle received from the image input unit 100 using a prestored image processing algorithm to determine boundary line information of a road on which the vehicle may travel and generate lighting pattern information for controlling a vehicle lamp (high beams).

The lamp control unit for a vehicle controls light-emitting states of a left high beam and a right high beam using the lighting pattern information generated by the image analysis unit 200. Specifically, since the camera sensor and the like is typically mounted in a central area of the vehicle (e.g., a rearview mirror, a front central portion of a hood, or the like), the forward image data of the vehicle acquired through these sensors includes both a light-emitting area (range) of the left high beam and a light-emitting area of the right high beam. Accordingly, the lamp control unit for a vehicle receives the generated lighting pattern information and controls a light source matching each (right or left) high beam. Since using lighting pattern information from th forward image data of the vehicle to control each high beam, that is, using a single lighting pattern to identify and control separate lighting pattern information suitable for each high beam corresponds to the conventional ADB technology, detailed descriptions of the control of the light-emitting state of each of the left and right high beams based on a single lighting pattern will be omitted.

Specifically, the image analysis unit 200 preferably includes a boundary line determination unit 210, an area segmentation unit 220, and a pattern generation unit 230, as illustrated in FIG. 1.

The boundary line determination unit 210 preferably analyzes the forward image data of the vehicle using the prestored image processing algorithm to determine the boundary line information of the road on which the vehicle may travel. In addition, prestored image processing algorithms include various image processing algorithms, such as a Canny edge detection algorithm, a Hough Transform algorithm, a convolutional neural network (CNN), a lane detection algorithm, and the like, and a single algorithm or a combination of two or more algorithms may be used to analyze the forward image data of the vehicle. Since the generation of the lighting pattern information through the analysis of the forward image data of the vehicle corresponds to the conventional ADB technology, detailed descriptions thereof will be omitted.

That is, the boundary line determination unit 210 uses the result of analyzing the forward image data of the vehicle to determine the boundary line information of the road on which the vehicle may travel based on whether a predetermined object within the forward image data of the vehicle is recognized (extracted). Here, the predetermined objects preferably include guardrails, road boundary lines, and the like, and in addition, various lane line information and roadside structure information, which may be determined to be the rightmost lane, are preferably set as the predetermined objects.

Based on this, when a guardrail, a legally stipulated road boundary line, and the like are recognized (extracted) within the forward image data of the vehicle, it is preferable to determine that the host vehicle is traveling in the rightmost lane and determine the corresponding predetermined object as boundary line information.

Alternatively, when the guardrail, the legally stipulated road boundary line, and the like are not recognized (extracted) in the forward image data of the vehicle, that is, when a predetermined object is not recognized within a predetermined distance from the right side of the host vehicle and at least one lane line information that is not set as the predetermined object is recognized, it is preferable to extract lane line information recognized farthest from the right side of the host vehicle among the recognized lane line information, that is, the outermost lane line information and determine that the extracted outermost lane line information is the boundary line information.

Alternatively, when the guardrail, the legally stipulated road boundary line, and the like are not recognized (extracted) in the forward image data of the vehicle, that is, when a predetermined object is not recognized within a predetermined distance from the right side of the host vehicle and at least one lane line information that is not set as the predetermined object is recognized, it is preferable to extract lane line information recognized farthest from the right side of the host vehicle among the recognized lane line information, that is, the outermost lane line information and generate a virtual boundary line at a position spaced a predetermined distance outward from the right side of the extracted outermost lane line information to determine that the generated virtual boundary line is the boundary line information.

Here, the predetermined distance is preferably set based on the legally stipulated distance between the rightmost lane line and the guardrail or between the rightmost lane line and the road boundary line, but is not specifically limited thereto.

In this way, the image processing algorithm for generating the virtual boundary line may be any algorithm capable of modeling and generating a virtual boundary line based on the recognized lane line, such as a polynomial fitting algorithm, spline interpolation, a lane offset generation algorithm, etc.

In this case, the present invention is described based on a right hand traffic area according to Korean traffic regulations, but is not necessarily limited thereto. Accordingly, the image analysis unit 200 does not necessarily consider the rightmost lane with respect to the traveling host vehicle or limit the right hand area of the boundary line information to the outer area. According to the legally stipulated traffic regulations, the leftmost lane with respect to the host vehicle may be considered, or the left hand area of the boundary line information may be limited to the outer area.

Preferably, the area segmentation unit 220 segments the outer area of the boundary line information determined by the boundary line determination unit 210 into at least three areas. In this case, preferably, the outer area is defined with respect to the vehicle, an area in which the vehicle is present is set as an inner area, an area in which no vehicle is present is set as the outer area, and the outer area is segmented into at least three areas.

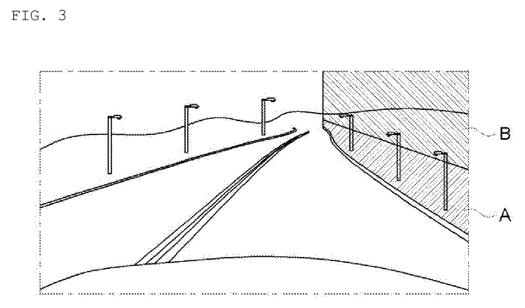

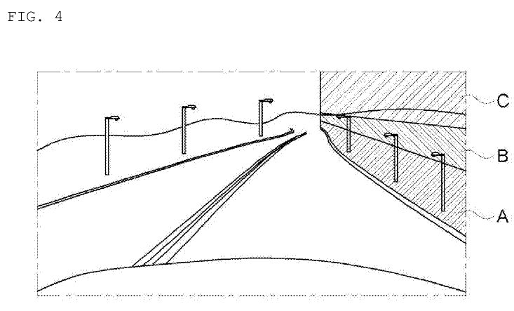

FIGS. 3 and 4 are examples illustrating lines drawn on the segmented areas by analyzing the received forward image data of the vehicle.

As illustrated in FIG. 3, the area segmentation unit 220 preferably bisects the outer area based on a predetermined height range from a road surface. For example, an area up to 1 m in height from the road surface may be segmented into area A, and an area above 1 m from the road surface may be segmented into area B.

That is, an area closest to the road surface may be segmented into a first segmentation area (area A), and the remaining area may be segmented into a second segmentation area (area B).

In addition, as illustrated in FIG. 4, the area segmentation unit 220 preferably segments the outer area into three areas based on the predetermined height range from the road surface. For example, an area up to 1 m in height from the road surface may be segmented into area A, an area that is more than 1 m and 1.8 m or less from the road surface may be segmented into area B, and an area exceeding 1.8 m from the road surface may be segmented into area C. That is, an area closest to the road surface may be segmented into the first segmentation area (area A), an area closest to the first segmentation area may be segmented into the second segmentation area (area B), and the remaining area may be segmented into the third segmentation area (area C).

Here, the height from the road surface used to segment the outer area is preferably set based on the vehicle height that affects the high beam emission conditions based on the height from the road surface segmenting the outer area, and is not limited to a specific value, and in the present invention, the outer area is segmented into at least three areas: an area in which visual information is necessary for the driver of the host vehicle, an area in which visual information is unnecessary, and an area in which visual information is less necessary.

The pattern generation unit 230 preferably generates lighting pattern information of the vehicle lamp based on the areas segmented by the area segmentation unit 220.

Referring to FIG. 3, lighting pattern information is generated so that the light sources corresponding to the second segmentation area (area B) are turned off or dimmed. That is, since visual information on the second segmentation area is relatively less important to the driver of the host vehicle, it is preferable to generate lighting pattern information so that the light sources illuminating the corresponding area are turned off or dimmed (with a relatively lower luminous intensity compared to the inner area of the boundary line information).

It is preferable to determine that the second segmentation area (area B) is an area in which the driver of the host vehicle does not need to recognize while driving, and since unnecessary glare may be caused to drivers of vehicles positioned in the oncoming lane, pedestrians positioned in the lane, or the like, turning off or dimming can minimize unnecessary energy waste and glare. In addition, even when highly reflective objects such as signs are present in the outer area, the illumination of these objects with a relatively low intensity can eliminate any difficulties in recognizing content resulting from reflection.

In addition, since the first segmentation area (area A) is preferably closer to the roadway than the second segmentation area (area B) and provides visual information to the driver of the host vehicle, it is preferable to generate lighting pattem information for the light sources corresponding to the first segmentation area (area A) using the same luminous intensity as the inner area of the boundary line information or through gradation control.

The term "gradation control" refers to generating lighting pattem information such that the farther the distance from the host vehicle, the lower the luminous intensity, that is, the luminous intensity gradually decreases with increasing distance.

Accordingly, it is possible to minimize unnecessary energy waste by iliuminating roadside areas adjacent to the host vehicle to be necessarily provided to the driver of the host vehicle with relatively high luminous intensity and illuminating areas of lesser importance with relatively low luminous intensity.

Referring to FIG. 4, lighting pattern information is generated so that the light sources corresponding to the second segmentation area (area B) and the third segmentation area (area C) are turned off or dimmed (with a relatively lower luminous intensity compared to the inner area of the boundary line information). In this case, the pattern generation unit 230 generates lighting pattern information that controls the light sources included in each of the second segmentation area (area B) and the third segmentation area (area C) to be turned off or dimmed equally or to be turned off and dimmed differently. That is, lighting pattern information is generated so that both the light sources included in the second segmentation area (area B) and the third segmentation area (area C) are turned off or dimmed, the light source included in the second segmentation area (area B) is dimmed and the light source included in the third segmentation area (area C) is dimmed, or the light source included in the second segmentation area (area B) is dimmed and the light source included in the third segmentation area (area C) is turned off. These control conditions are set in consideration of a body height of a host vehicle, a high beam emission angle of the host vehicle, and the like and are not limited.

However, it is preferable to determine that the second segmentation area (area B) and the third segmentation area (area C) are areas in which the driver of the host vehicle does not need to perceive while driving, and since unnecessary glare may be caused to drivers of vehicles positioned in the oncoming lane, pedestrians positioned in the lane, or the like, turning off or dimming can minimize unnecessary energy waste and glare. In addition, even when highly reflective objects such as signs are present in the outer area, the illumination of these objects with a relatively low intensity can eliminate any difficulties in recognizing content resulting from reflection.

In addition, since the first segmentation area (area A) is preferably closer to the roadway than the second segmentation area (area B) or the third segmentation area (area C) and provides visual information to the driver of the host vehicle, it is preferable to generate lighting pattern information for the light sources corresponding to the first segmentation area (area A) using the same luminous intensity as the inner area of the boundary line information or through gradation control.

The term “gradation control” refers to generating lighting pattern information such that the farther the distance from the host vehicle, the lower the luminous intensity, that is, the luminous intensity gradually decreases with increasing distance.

Accordingly, it is possible to minimize unnecessary energy waste by illuminating roadside areas adjacent to the host vehicle to be necessarily provided to the driver of the host vehicle with relatively high luminous intensity and illuminating areas of lesser importance with relatively low luminous intensity.

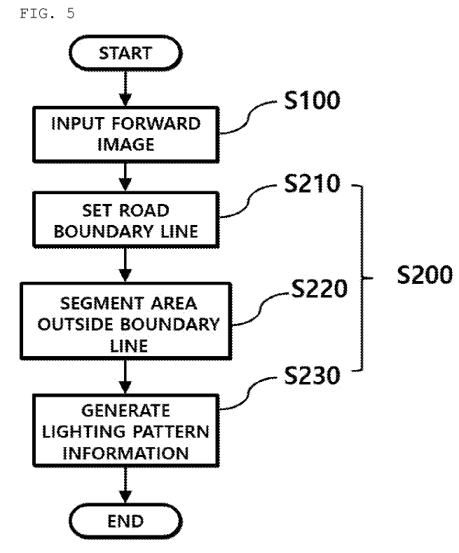

FIG. 5 is an exemplary flowchart illustrating a method of controlling a vehicle lamp according to an embodiment of the present invention, and the method of controlling a vehicle lamp according to the embodiment of the present invention includes an image input operation S100 and an image analysis operation S200. Each operation is performed using a lamp control system for a vehicle, which is implemented by a computational processing unit including a CPU or the like.

Detailed descriptions of each operation will be described in detail below.

The image input operation S100 includes receiving, by the image input unit 100, forward image data of the vehicle from a camera sensor and the like mounted on the vehicle. The vehicle forward image data refers to a forward image of the vehicle while traveling and includes various lane line information and roadside structure information. For example, the forward image data of the vehicle includes various lane line information and roadside structure information, such as white lane lines (lane boundary lines for the same direction), yellow lane lines (lane boundary lines for oncoming lanes), blue lane lines (lane boundary lines for bus-only lanes), dotted lines (lane changeable section of a lane available for same-direction travel), solid lines (sections in which lane changes are not possible), double solid lines (sections in which lane changes or parking are not possible), guardrails, medians, streetlights, etc.

The image analysis operation S200 includes analyzing, by the image analysis unit 200, the forward image data of the vehicle received through the image input operation S100 using the prestored image processing algorithm to generate lighting pattern information to control the vehicle lamp (high beams) based on the determined boundary line information.

The lamp control unit for a vehicle controls light-emitting states of a left high beam and a right high beam using the lighting pattern information generated through the image analysis operation S200. Specifically, since the camera sensor and the like is typically mounted in a central area of the vehicle (e.g., a rearview mirror, a front central portion of a hood, or the like), the forward image data of the vehicle acquired through these sensors includes both a light-emitting area (range) of the left high beam and alight-emitting area of the right high beam. Accordingly, the lamp control unit for a vehicle receives the generated lighting pattem information and controls a light source matching each (right or left) high beam. Since using lighting pattem information from th forward image data of the vehicle to control each high beam, that is, using a single lighting pattem to identify and control separate lighting pattern information suitable for each high beam corresponds to the conventional ADB technology, detailed descriptions of the control of the light-emitting state of each of the left and right high beams based on a single lighting pattem will be omitted.

In this case, the image analysis operation S200 includes a boundary line determination operation S210, an area segmentation area S220, and a pattern generation operation S230, as illustrated in FIG. 5.

The boundary line determination operation S210 includes analyzing the forward image data of the vehicle using the prestored image processing algorithm to determine the boundary line information of the road on which the vehicle may travel. Here, the prestored image processing algorithms include various image processing algorithms, such as a Canny edge detection algorithm, a Hough Transform algorithm, a convolutional neural network (CNN), a lane detection algorithm, and the like, and a single algorithm or a combination of two or more algorithms may be used to analyze the forward image data of the vehicle. Since the generation of the lighting pattem information through the analysis of the forward image data of the vehicle corresponds to the conventional ADB technology, detailed descriptions thereof will be omitted.

The boundary line determination operation S210 includes using the result of analyzing the forward image data of the vehicle to determine the boundary line information of the road on which the vehicle may travel based on whether a predetermined object within the forward image data of the vehicle is recognized (extracted). Here, the predetermined objects preferably include guardrails, road boundary lines, and the like, and in addition, various lane line information and roadside structure information, which may be determined to be the rightmost lane, are preferably set as the predetermined objects.

Based on this, when a guardrail, a legally stipulated road boundary line, and the like are recognized (extracted) within the forward image data of the vehicle, it is preferable to determine that the host vehicle is traveling in the rightmost lane and determine the corresponding predetermined object as boundary line information.

Alternatively, when the guardrail, the legally stipulated road boundary line, and the like are not recognized (extracted) in the forward image data of the vehicle, that is, when a predetermined object is not recognized within a predetermined distance from the right side of the host vehicle and at least one lane line information that is not set as the predetermined object is recognized, the boundary line determination operation S210 includes extracting lane line information recognized farthest from the right side of the host vehicle among the recognized lane line information, that is, the outermost lane line information and determining that the extracted outermost lane line information is the boundary line information.

Alternatively, when the guardrail, the legally stipulated road boundary line, and the like are not recognized (extracted) in the forward image data of the vehicle, that is, when a predetermined object is not recognized within a predetermined distance from the right side of the host vehicle and at least one lane line information that is not set as the predetermined object is recognized, the boundary like determination operation S210 includes extracting lane line information recognized farthest from the right side of the host vehicle among the recognized lane line information, that is, the outermost lane line information and generating a virtual boundary line at a position spaced a predetermined distance outward from the right side of the extracted outermost lane line information to determine that the generated virtual boundary line is the boundary line information.

Here, the predetermined distance is preferably set based on the legally stipulated distance between the rightmost lane line and the guardrail or between the rightmost lane line and the road boundary line, but is not specifically limited thereto.

In this way, the image processing algorithm for generating the virtual boundary line may be any algorithm capable of modeling and generating a virtual boundary line based on the recognized lane line, such as a polynomial fitting algorithm, spline interpolation, a lane offset generation algorithm, etc.

In this case, the present invention is described based on a right hand traffic area according to Korean traffic regulations, but is not necessarily limited thereto. Accordingly, the present invention does not necessarily consider the rightmost lane with respect to the traveling host vehicle or limit the right hand area of the boundary line information to the outer area. According to the legally stipulated traffic regulations, the leftmost lane with respect to the host vehicle may be considered, or the left hand area of the boundary line information may be limited to the outer area.

The area segmentation operation S220 includes segmenting the outer area of the boundary line information determined through the boundary line determination operation S210 into at least three areas. In this case, preferably, the outer area is defined with respect to the vehicle, an area in which the vehicle is present is set as an inner area, an area in which no vehicle is present is set as the outer area, and the outer area is segmented into at least three areas.

FIGS. 3 and 4 are examples illustrating lines drawn on the segmented areas by analyzing the received forward image data of the vehicle.

As illustrated in FIG. 3, the area segmentation operation S220 preferably includes bisecting the outer area based on a predetermined height range from a road surface. For example, an area up to 1 m in height from the road surface may be defined as area A, and an area above 1 m from the road surface may be defined as area B.

That is, an area closest to the road surface may be segmented into a first segmentation area (area A), and the remaining area may be segmented into a second segmentation area (area B).

In addition, as illustrated in FIG. 4, the area segmentation operation S220 preferably includes segmenting the outer area into three areas based on a predetermined height range from a road surface. For example, an area up to 1 m in height from the road surface may be segmented into area A, an area that is more than 1 m and 1.8 m or less from the road surface may be segmented into area B, and an area exceeding 1.8 m from the road surface may be segmented into area C. That is, an area closest to the road surface may be segmented into the first segmentation area (area A), an area closest to the first segmentation area may be segmented into the second segmentation area (area B), and the remaining area may be segmented into the third segmentation area (area C).

Here, the height from the road surface used to segment the outer area is preferably set based on the vehicle height that affects the high beam emission conditions based on the height from the road surface segmenting the outer area, and is not limited to a specific value, and in the present invention, the outer area is segmented into at least three areas: an area in which visual information is necessary for the driver of the host vehicle, an area in which visual information is unnecessary, and an area in which visual information is less necessary.

The pattern generation operation S230 includes generating lighting pattern information for a vehicle lamp based on the areas segmented in the area segmentation operation S220.

Referring to FIG. 3, the pattern generation operation S230 includes generating lighting pattern information so that light sources corresponding to the second segmentation area (area B) are turned off or dimmed. That is, since visual information on the second segmentation area is relatively less important to the driver of the host vehicle, it is preferable to generate lighting pattern information so that the light sources illuminating the corresponding area are turned off or dimmed (with a relatively lower luminous intensity compared to the inner area of the boundary line information).

It is preferable to determine that the second segmentation area (area B) is an area in which the driver of the host vehicle does not need to perceive while driving, and since unnecessary glare may be caused to drivers of vehicles positioned in the oncoming lane, pedestrians positioned in the lane, or the like, turning off or dimming can minimize unnecessary energy waste and glare. In addition, even when highly reflective objects such as signs are present in the outer area, the illumination of these objects with a relatively low intensity can eliminate any difficulties in recognizing content resulting from reflection.

In addition, since the first segmentation area (area A) is preferably closer to the roadway than the second segmentation area (area B) and provides visual information to the driver of the host vehicle, the pattern generation operation S230 preferably includes generating lighting pattern information for the light sources corresponding to the first segmentation area (area A) using the same luminous intensity as the inner area of the boundary line information or through gradation control.

The term “gradation control” refers to generating lighting pattern information such that the farther the distance from the host vehicle, the lower the luminous intensity, that is, the luminous intensity gradually decreases with increasing distance.

Accordingly, it is possible to minimize unnecessary energy waste by illuminating roadside areas adjacent to the host vehicle to be necessarily provided to the driver of the host vehicle with relatively high luminous intensity and illuminating areas of lesser importance with relatively low luminous intensity.

Alternatively, referring to FIG. 4, the pattern generation operation S230 includes generating lighting pattern information is generated so that the light sources corresponding to the second segmentation area (area B) and the third segmentation area (area C) are turned off or dimmed (with a relatively lower luminous intensity compared to the inner area of the boundary line information). In this case, the pattern generation operation S230 includes generating lighting pattern information that controls the light sources included in each of the second segmentation area (area B) and the third segmentation area (area C) to be turned off or dimmed equally or to be turned off and dimmed differently. That is, lighting pattern information is generated so that both the light sources included in the second segmentation area (area B) and the third segmentation area (area C) are turned off or dimmed, the light source included in the second segmentation area (area B) is dimmed and the light source included in the third segmentation area (area C) is dimmed, or the light source included in the second segmentation area (area B) is dimmed and the light source included in the third segmentation area (area C) is turned off. These control conditions are set in consideration of a body height of a host vehicle, a high beam emission angle of the host vehicle, and the like and are not limited.

However, it is preferable to determine that the second segmentation area (area B) and the third segmentation area (area C) are areas in which the driver of the host vehicle does not need to perceive while driving, and since unnecessary glare may be caused to drivers of vehicles positioned in the oncoming lane, pedestrians positioned in the lane, or the like, turning off or dimming can minimize unnecessary energy waste and glare. In addition, even when highly reflective objects such as signs are present in the outer area, the illumination of these objects with a relatively low intensity can eliminate any difficulties in recognizing content resulting from reflection.

In addition, since the first segmentation area (area A) is preferably closer to the roadway than the second segmentation area (area B) or the third segmentation area (area C) and provides visual information to the driver of the host vehicle, the pattern generation operation S230 preferably includes generating lighting pattern information for the light sources corresponding to the first segmentation area (area A) using the same luminous intensity as the inner area of the boundary line information or through gradation control.

The term “gradation control” refers to generating lighting pattern information such that the farther the distance from the host vehicle, the lower the luminous intensity, that is, the luminous intensity gradually decreases with increasing distance.

The present invention may be implemented as computer-readable codes on a medium on which a program is recorded. The computer-readable medium includes any type of recording device in which data that may be read by a computer system are stored. Examples of the computer-readable media include a hard disk drive (HDD), a solid state disk (SSD), a silicon disk drive (SDD), a read only memory (ROM), a random access memory (RAM), a CD-ROM, a magnetic tape, a floppy disk, an optical data storage device, and the like, and also include one implemented in the form of carrier waves (e.g., transmission via Internet). In addition, the computer may include the lamp control system for a vehicle and the method of controlling the same according to the present invention.

According to the lamp control system for a vehicle and the method of controlling the same of the present invention, by distinguishing the boundary line of the travelable road of the vehicle and controlling the intensity and height of light in the area outside the boundary lines in which the vehicle cannot travel, it is possible to provide maximum visibility to the driver of the host vehicle and minimizing glare to users (e.g., pedestrians) present in the outer area.

In addition, it is possible to prevent low visibility caused by high beam reflections when highly reflective objects are present in the outer area.

In particular, by segmenting the front area of the host vehicle in greater detail to generate lighting pattern information, precise lighting control suitable for HD-ADB technology can be possible.

Although the exemplary embodiments of the present disclosure have been described above, the embodiments disclosed in the present disclosure are not intended to limit the technical spirit of the present disclosure but are only for description. Accordingly, the technical spirit of the present disclosure includes not only each disclosed embodiment, but also a combination of the disclosed embodiments, and furthermore, the scope of the technical spirit of the present disclosure is not limited by these embodiments. In addition, those skilled in the art to which the present disclosure pertains can variously change and modify the present disclosure without departing from the spirit and scope of the appended claims, and all such appropriate changes and modifications should be regarded as belonging to the scope of the present disclosure as equivalents.

### DESCRIPTION OF REFERENCE NUMERALS

100: image input unit

200: image analysis unit

210: boundary line setting unit

220: area segmentation unit 230: pattern generation unit

230: pattern generation unit

What is claimed is:

1. A lamp control system for a vehicle, comprising:
an image input unit configured to receive forward image data of the vehicle from a camera sensor; and
an image analysis unit configured to analyze the forward image data of the vehicle using an image processing algorithm to determine boundary line information of a travelable road and to generate lighting pattern information to control a vehicle lamp based on the boundary line information,
wherein the vehicle lamp includes a plurality of light sources, each of which has at least one of a light-emitting position and a light intensity controlled according to the lighting pattern information.

2. The lamp control system of claim 1, wherein the image analysis unit includes:
a boundary line determination unit configured to analyze the forward image data of the vehicle to determine the boundary line information of the travelable road of the vehicle;
an area segmentation unit configured to segment an outer area outside the determined boundary line information into a plurality of areas based on the vehicle; and
a pattern generation unit configured to generate the lighting pattern information based on the segmented areas.

3. The lamp control system of claim 2, wherein the boundary line determination unit analyzes the forward image data of the vehicle and, when a predetermined object is recognized, determines the boundary line information based on the corresponding predetermined object.1

4. The lamp control system of claim 2, wherein the boundary line determination unit analyzes the forward image data of the vehicle and, when no predetermined object is recognized, determines that an outermost lane line among recognized lane lines is the boundary line information.

5. The lamp control system of claim 2, wherein, when no predetermined object is recognized by analyzing the forward image data of the vehicle, a virtual boundary line is generated outside a recognized lane line, and the generated virtual boundary line is determined to be the boundary line information.

6. The lamp control system of claim 2, wherein the area segmentation unit segments the outer area, based on a predetermined height range from a road surface, into a first segmentation area closest to the road surface and a second segmentation area comprising the remaining outer area, and
the pattern generation unit generates the lighting pattern information so that light sources corresponding to the second segmentation area are turned off or dimmed.

7. The lamp control system of claim 2, wherein the area segmentation unit segments the outer area, based on a predetermined height range from a road surface, into a first segmentation area closest to the road surface a second segmentation area closest to the first segmentation area, and a third segmentation area comprising the remaining outer area, and
the pattern generation unit generates the lighting pattern information so that light sources corresponding to the second segmentation area and the third segmentation area 2

8. The lamp control system of claim 6, wherein the pattern generation unit generates the lighting pattern information so that a luminous intensity of each light source corresponding to the first segmentation area gradually decreases as a distance from a host vehicle increases.

9. The lamp control system of claim 7, wherein the pattern generation unit generates the lighting pattern information so that a luminous intensity of each light source corresponding to the first segmentation area gradually decreases as a distance from a host vehicle increases.

10. A method of controlling a vehicle lamp, in which each operation is performed by a computational processing unit, the method comprising:
an image input operation of receiving forward image data of a vehicle from a camera sensor; and
an image analysis operation of analyzing the forward image data of the vehicle received in the image input operation using an image processing algorithm to determine boundary line information of a travelable road and to generate lighting pattern information to control a vehicle lamp based on the boundary line information.

11. The method of claim 10, wherein the image analysis operation includes:3
a boundary line determination operation of analyzing the forward image data of the vehicle to determine the boundary line information of the travelable road of the vehicle;
an area segmentation operation of segmenting an outer area outside the determined boundary line information into a plurality of areas based on the vehicle; and
a pattern generation operation of generating the lighting pattern information based on the segmented areas.

12. The method of claim 11, wherein the boundary line determination operation includes analyzing the forward image data of the vehicle and, when a predetermined object is recognized, determining the boundary line information based on the corresponding predetermined object.

13. The method of claim 11, wherein, when no predetermined object is recognized by analyzing the forward image data of the vehicle, the boundary line determination operation includes determining that an outermost lane line among recognized lane lines is the boundary line information or generating a virtual boundary line outside the recognized lane line, and determining that the generated virtual boundary line is the boundary line information.

14. The method of claim 11, wherein the area segmentation operation includes segmenting the outer area, based on a predetermined height range from a road surface, into a first segmentation area closest to the road surface and a second segmentation area comprising the remaining out area, and4
the pattern generation operation includes generating the lighting pattern information so that light sources corresponding to the second segmentation area are turned off or dimmed.

15. The method of claim 11, wherein the area segmentation operation includes segmenting the outer area, based on a predetermined height range from a road surface, into a first segmentation area closest to the road surface a second segmentation area closest to the first segmentation area, and a third segmentation area comprising the remaining outer area, and
the pattern generation operation includes generating the lighting pattern information so that light sources corresponding to the second segmentation area and the third segmentation area are turned off or dimmed in the same manner or so that the light sources corresponding to the second segmentation area and the light sources corresponding to the third segmentation area are turned off or dimmed differently.

16. The method of claim 14, wherein the pattern generation operation includes generating the lighting pattern information so that a luminous intensity of each light source corresponding to the first segmentation area gradually decreases as a distance from a host vehicle increases.

17. The method of claim 15, wherein the pattern generation operation includes generating the lighting pattern information so that a luminous intensity of each light source corresponding to the first segmentation area gradually decreases as a distance from a host vehicle increases.

18. The lamp control system of claim 5, wherein the area segmentation unit segments the outer area into at least three areas, and the pattem generation unit generates the lighting pattern information so that light sources corresponding to all but the first segmentation area are turned off or dimmed.

19. The method of claim 13, wherein the area segmentation operation segments the outer area into at least three areas, and the pattem generation operation generates the lighting pattern information so that light sources corresponding to all but the first segmentation area are turned off or dimmed.

20. The method of claim 10, further comprising controlling the vehicle lamp using the lighting pattern information to illuminate an inner area inside the boundary line information at a first luminous intensity and to illuminate each of the segmented areas of the outer area at a second luminous intensity lower than the first luminous intensity.
